(19) United States
(12) Patent Application Publication
(10) Pub. No.: US 2002/0117859 A1
(43) Pub. Date: Aug. 29, 2002

(54) Multi-cylinder stationary internal combustion engine

(76) Inventors: Markus Kraus, Jenbach (AT); Friedrich Gruber, Hippach (AT)

Correspondence Address: Lorusso & Loud, 440 Commercial Street, Boston, MA, 02109, US

(21) Appl. No.: 10/051,319

(22) Filed: Jan. 18, 2002

(30) Foreign Application Priority Data
Jan. 19, 2001 (AT) A 90/2001

(51) Int. Cl. H02P 9/04; F02N 11/06

(52) U.S. Cl. 290/41

(57) ABSTRACT

Multi-cylinder stationary internal combustion engine for driving at least one generator for the production of electric current, the internal combustion engine having a control device which selectively disconnects one or more cylinders during operation according to at least one control signal.

The present invention relates to a multi-cylinder stationary internal combustion engine for driving at least one generator for the production of electric current.

Stationary internal combustion engines which are used to drive generators are known in the state of the art. Sudden taking off of load at the generator during operation of the internal combustion engine can easily lead to an increase in the speed of the internal combustion engine. The same applies for the uncoupling of the internal combustion engine from the generator or other sudden changes in the operational states. In the state of the art, these load changes are absorbed in extreme cases by an overspeed disconnection of the internal combustion engine, which however brings with it an undesirably abrupt intervention in the operation of the internal combustion engine. In general, the problem of matching the regulation of the speed of a stationary internal combustion engine to the extent of the change in the event of a sudden drop in load in the generator which drives it still awaits a satisfactory solution.

The object of the invention is thus to create a possibility, in stationary internal combustion engines, to prevent increased speeds of the internal combustion engine in the event of sudden changes in the operating conditions of the internal combustion engine.

This is achieved according to the invention in that the internal combustion engine has a control device which selectively disconnects one or more cylinders during operation according to at least one control signal.

Admittedly, it is known in the case of mobile internal combustion engines which drive e.g. motor vehicles or similar, in order to adjust the operating conditions of the mobile internal combustion engine, to selectively disconnect one or more cylinders. However, in mobile internal combustion machines, different operating conditions and changes of state are generally to be absorbed and regulated.

Thus the cylinder-selective disconnection is often used in particular here to save fuel in mobile internal combustion engines in e.g. passenger cars with many cylinders or for slip adjustment.

The cylinder-selective disconnection is used according to the invention primarily to avoid overspeed disconnection during full-load operation. By the term disconnection is meant here that, through the disconnection cylinders no longer work actively, but the piston housed in them only travels passively. This can be achieved in various ways, e.g. by interrupting the fuel supply to the cylinder or by disconnecting the firing mechanism of the cylinder. The disconnection of the cylinders must be matched to each situation, in order that criteria explained as follows are satisified. First to be mentioned is the avoidance of overspeed without the complete stoppage of the internal combustion engine. Furthermore, by using the selective disconnection according to the invention of individual or several cylinders after the shedding of load, the internal combustion engine regains the required rated speed as quickly as possible. By cylinder-selective disconnection using a suitable control device, it is simultaneously guaranteed that no overload is placed on the other cylinders still in operation. The invention can in particular be used for gas engines.

A preferred version provides that the control signal for the cylinder disconnection depends on the load at the generator. In the case of stationary internal combustion engines, the load at the generator is an important influencing parameter which determines the output to be achieved by the internal combustion engine. If a sudden load reduction occurs at the generator, the internal combustion engine would suddenly increase speed without the intervention according to the invention, which could lead, without a controlling intervention, to the damaging or destruction of the internal combustion engine. Through the selective disconnection according to the invention of individual or several cylinders of the internal combustion engine driving the generator, according to the load at the generator, such undesired increases in speed are regulated and prevented. The energy which is produced in the case of a sudden shedding of load and which would lead to an increase in speed were the consumer disconnected, is dissipated by disconnecting one or more cylinders. Above all in the case of shedding of load in full-load operation, an overspeed can thus be prevented.

A preferred variant according to the invention provides that the cylinder disconnection takes place at least one cylinder by disconnecting the respective firing mechanism. For example, in the case of a freely adjustable number of cylinders, the firing mechanism can be disconnected for a freely adjustable period of time. It is important, for as small an overspeed as possible to disconnect the firing mechanism at individual cylinders as soon as possible.

A further preferred version of the internal combustion engine according to the invention provides that it has a generator switch for coupling and uncoupling the generator respectively to and from at least one consumer, the generator switch triggering, upon uncoupling of the generator, a control signal for cylinder disconnection.

Another variant according to the invention provides that an internal combustion engine is equipped with a mechanical or hydraulic clutch coupling to the generator and a device for monitoring the coupling status, the device for monitoring the coupling status triggering, upon opening of the clutch coupling, a control signal for cylinder disconnection.

Alternatively, it is also provided according to the invention that an internal combustion engine is equipped with a control device which corresponds to a device for measurement—in particular electrical or mechanical—of the load change at the generator, the device for measuring the load change triggering a control signal for cylinder disconnection. Cylinder disconnection can thereby be activated e.g. in the case of a drop in load and an overspeed disconnection of the internal combustion engine thus prevented.

A preferred version furthermore provides that the internal combustion engine has a control device for preventing explosions during cylinder disconnection. According to the invention the number of cylinders can be chosen such that the mixture between burned and unburned exhaust gas in the exhaust pipe remains below the ignition limit. If this is the case there are no explosions in the exhaust pipe which could lead to the partial damage or to the destruction of the internal combustion engine.

Structurally, it is particularly favourable that the internal combustion engine has a control device, the control device determining the number of cylinders to be disconnected according to the amplitude and/or the chronology of the—preferably electrically or mechanically—measured load change. Both the matching of the number of the cylinders to be disconnected to the load change and the distribution of these cylinders over the whole internal combustion engine is important.

A further version according to the invention provides that the internal combustion engine has a control device which determines the chronology of the disconnection according to the amplitude and/or the chronology of the—preferably electrically or mechanically—measured load change. Through this matching of the disconnection times of individual or several cylinders, an abrupt involvement of the control device in the operating conditions of the internal combustion engine is prevented and a restrained control procedure, adapted to the momentary load at the internal combustion engine, is achieved.

Following the disconnection of one or more cylinders, the moment of reconnection of the cylinder or cylinders can be fixed by a time or an event. Thus, on the one hand, one variant according to the invention provides that the internal combustion engine has a control device, this control device carrying out the reconnection of the disconnected cylinders after a specific period of time has elapsed. Alternatively, it is provided according to the invention that the internal combustion engine has a control device, the control device carrying out the reconnection of the disconnected cylinders according to a control signal preferably measured at the generator and/or at the internal combustion engine. A particularly preferred version of the invention provides that the internal combustion engine has a control device which carries out the reconnection of the disconnected cylinders, according to the load change—preferably electrically and/or mechanically measured at the generator.

Further features and details of the present invention emerge from the following description of the FIGURE. There is shown in:

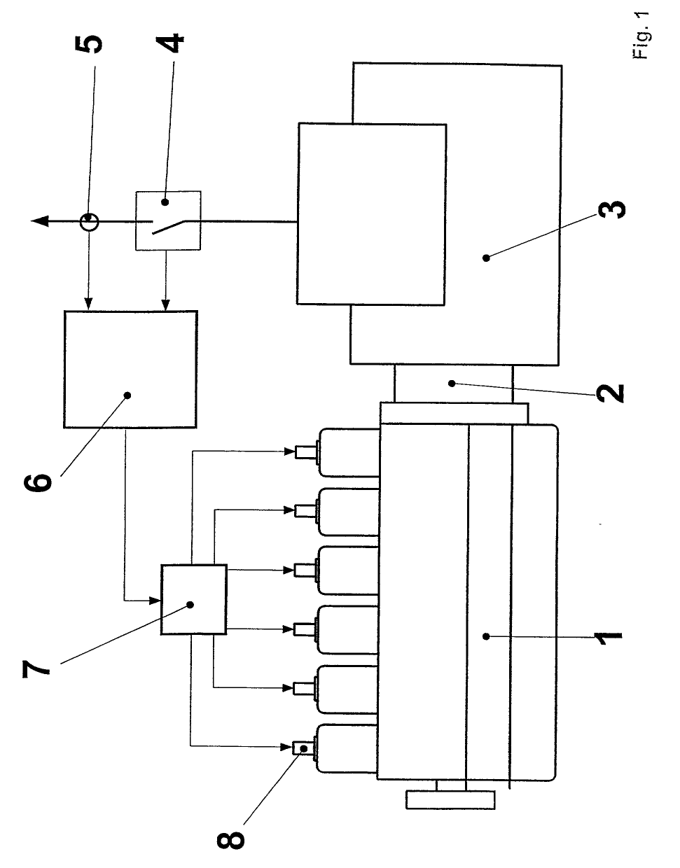

FIG. 1 a schematic structure comprising internal combustion engine and generator with corresponding measuring and control devices.

In FIG. 1, the internal combustion engine 1 is connected to the generator 3 via the clutch coupling 2. The generator 3 is connected to at least one consumer via the generator switch 4. An output meter 5 is provided in the associated connection line, which measures the output and thus the load change at the generator. In FIG. 1, both the output meter 5 and the generator switch 4 transmit control signals to the control device 6. The latter is connected to the firing mechanism 7 which can selectively switch on and off the ignition coils 8 for the individual cylinders. Through this arrangement according to the invention, one or more cylinders can be disconnected by the control device 6 upon a sudden load change or when the generator switch is opened, and reconnected after a load adjustment or a previously specified time.

1. Multi-cylinder stationary internal combustion engine for driving at least one generator for the production of electric current, characterized in that the internal combustion engine has a control device which selectively disconnects one or more cylinders during operation according to at least one control signal.

2. Internal combustion engine according to claim 1, characterized in that the control signal for cylinder disconnection depends on the load at the generator.

3. Internal combustion engine according to claim 1, characterized in that cylinder disconnection takes place at least one cylinder by disconnecting the respective firing mechanism.

4. Internal combustion engine with a generator switch for coupling and uncoupling the generator respectively to and from at least one consumer according to claim 1, characterized in that the generator switch, when the generator is uncoupled, triggers a signal for the cylinder disconnection.

5. Internal combustion engine with a mechanical or hydraulic clutch coupling to the generator and a device for monitoring the coupling status according to one claim 1, characterized in that the device for monitoring the coupling status when the clutch coupling is opened, triggers a control signal for the cylinder disconnection.

6. Internal combustion engine with a control device which corresponds to a device for the measurement of the load change at the generator, according to claim 1, characterized in that the device for measuring the load change triggers a control signal for the cylinder disconnection.

7. Internal combustion engine according to claim 1, characterized in that the internal combustion engine has a control device for preventing explosions upon cylinder disconnection.

8. Internal combustion engine according to claim 1, characterized in that the internal combustion engine has a control device, the control device determining the number of cylinders to be disconnected according to the amplitude or the chronology of the load change.

9. Internal combustion engine according to claim 1, characterized in that the internal combustion engine has a control device which determines the chronology of the disconnection according to the amplitude and/or the chronology of the load change.

10. Internal combustion engine according to claim 1, characterized in that the internal combustion engine has a control device, this control device carrying out the reconnection of the disconnected cylinders after a certain period of time has elapsed.

11. Internal combustion engine according to claim 1, characterized in that the internal combustion engine has a control device, this control device carrying out the reconnection of the disconnected cylinders according to a control signal.

12. Internal combustion engine according to claim 1, characterized in that the internal combustion engine has a control device which carries out the reconnection of the disconnected cylinders according to the load change.

13. Internal combustion engine according to claim 1, characterized in that it is a gas engine.

14. Internal combustion engine according to claim 11, characterized in that the control signal is measured at the generator or at the internal combustion engine.

15. Internal combustion engine according to claim 12, characterized in that the load change is measured electrically or mechanically at the generator.
